(19) United States
(12) Patent Application Publication
(10) Pub. No.: US 2009/0294249 A1
(43) Pub. Date: Dec. 3, 2009

(54) Device For Transporting Workpiece Holders

(76) Inventors: Peter Schlaich, Leonberg (DE); Joachim Frangen, Heilbronn (DE); Frank Benkert, Bad Brückenau-Volkers (DE); Wolfram Baier, Ostfildern (DE); Ka-Jin Teoh, Essen (DE)

Correspondence Address: KENYON & KENYON LLP, ONE BROADWAY, NEW YORK, NY, 10004, US

(21) Appl. No.: 11/988,068

(22) PCT Filed: Jul. 27, 2006
(86) PCT No.: PCT/EP2006/064753

§ 371 Date: Jun. 2, 2009

(30) Foreign Application Priority Data
Aug. 25, 2005 (DE) 10 2005 040 165.1

(51) Int. Cl. B65G 47/34

(52) U.S. Cl. 198/346.1

(57) ABSTRACT

A device is described for transporting workpiece holders between multiple processing stations, a traction mechanism conveyor line being provided having at least one conveyor unit and at least one transfer unit for transferring the workpiece holders between the traction mechanism conveyor line and a processing station. The workpiece holders lie loosely on the traction mechanism conveyor line and project laterally beyond the traction mechanism conveyor line, and the transfer unit is situated at least partially below the conveyor plane and movable perpendicular thereto in such a way that the workpiece holders are graspable from below by the transfer unit at their area projecting beyond the traction mechanism conveyor line.

### FIELD OF THE INVENTION

The present invention relates to a device for transporting workpiece holders.

### BACKGROUND INFORMATION

So-called transfer systems, which transport a workpiece holder having a component to be processed as the workpiece from one processing station to a next processing station, are used as transport devices in manufacturing technology for automated assembly and part manufacturing. A frequently used transfer system operates using a conveyor belt, e.g., a twin-belt conveyor, which transports and guides the workpiece holder.

For example, such a conveyor line for piece goods and in particular for workpiece holders, which has two parallel holding units situated at a distance, on which holding means are situated, at least one of which is a traction mechanism and which forms a conveyor plane for the piece goods and/or the workpiece holders, is described in German Patent Application No. DE 100 32 189 B4.

This described conveyor line is also referred to as a loose linkage, in which the positioning precision between the workpiece on the workpiece holder and a processing module for processing the workpiece is an important variable, so that the workpiece holder having the component to be processed must be removed from the conveyor line and supplied to the processing module via precisely guided indexing pins, to thus meet the high precision requirements.

Relatively long component changing times and complexly designed processing stations, which are not fully utilized during the long component changing times, result therefrom. Nonetheless, such loose linkages are valued in practice because of their system robustness, their congestion capability, i.e., their capability to buffer subsequent workpiece holders in front of a processing station and thus allow chronological decoupling of work processes, and the possibility of implementing branches, e.g., to operate double stations.

Furthermore, so-called rigid linkages and/or couplings as a configuration for transportation are also conventional, in which all workpiece holders having the components to be processed are moved synchronously from one processing station to the next processing station. Because the workpiece holders are coupled to one another and are thus positively driven, the entire component composite moves in step.

Although such a rigid linkage allows relatively rapid workpiece holder changing times and a simple workpiece holder controller, it disadvantageously causes rigid chronological coupling of the manufacturing at the individual processing stations. In addition, no branches may be implemented in this type of transport unit, and a complex mechanism is necessary to guarantee the workpiece holder positioning precision in the manufacturing system.

German Patent No. DE 37 30 972 A1 describes a conveyor line between multiple sequentially situated assembly, processing, or testing stations, in which the workpiece transport occurs on workpiece holders in the individual stations via a transport unit, on which buffers for workpiece holders are formed in front of the stations. Pre-fixing and transport units, which pre-fix the workpiece holders in a ready position of the buffer and then transport them positively controlled into the assigned fixing and clamping unit for the workpiece holders in the following station, are used to shorten the cycle time. An assembly line may be implemented in a modular construction.

The conventional traction mechanism conveyor lines frequently have problems in removing the workpiece holders from the conveyor and returning them to the conveyor using a gripper unit because the gripper unit usually requires a comparatively large installation space and projects into the processing space.

### SUMMARY

An object of the present invention is to provide a device for transporting workpiece holders in which a transfer unit between a traction mechanism conveyor line and a processing space, in particular with a modular construction of the traction mechanism conveyor line, impairs the processing space as little as possible.

According to an example embodiment of the present invention, a device is provided for transporting workpiece holders between multiple processing stations, a traction mechanism conveyor line having at least one conveyor unit and at least one transfer unit for transferring the workpiece holders between the traction mechanism conveyor line and a processing station being provided, and, according to an example embodiment of the present invention, the workpiece holders lying loosely on the traction mechanism conveyor line and projecting laterally beyond it and the transfer unit being situated at least partially below the conveyor plane and being movable perpendicular thereto in such a way that the workpiece holders are graspable from below by the transfer unit at their area projecting beyond the traction mechanism conveyor line.

A device of this type has the advantage that the transfer unit may be attached easily below the conveyor plane without projecting into a processing space of the processing station.

Such access to the workpiece holders from below is favorable in particular for a compact construction of the traction mechanism conveyor line, as may exist with a modular construction having a particular assigned processing module.

Furthermore, such a configuration and mode of access of the transfer unit allows a simple relocation movement of the workpiece holders, which, with such a configuration of the transfer unit, may be relocated by simple lifting and rotation or linear displacement.

In an advantageous embodiment of the present invention, the traction mechanism conveyor line includes, as conveyor units, an intake belt for supplying the workpiece holders and a return belt, situated parallel thereto at a distance, for returning the workpiece holders. A single-belt conveyor, a double-belt conveyor, and/or a roller belt conveyor may be used as the intake belt and as the return belt, one skilled in the art also being able to use any other type of conveyor unit suitable for the particular application, however.

According to an advantageous embodiment of the device according to the present invention, the traction mechanism conveyor line may be constructed from multiple transport modules forming a continuous transport pathway, each transport module being assigned to a specific processing station and having at least one conveyor unit and one transfer unit for the workpiece holders.

A loose linkage and all of the advantages connected to this type of workpiece holder transport are achieved by such a modular embodiment of the traction mechanism conveyor line. In addition to a robust and cost-effective design of the transport modules, for example, short component changing times and chronological decoupling of the individual manufacturing processes in the processing stations may be implemented in that, for example, workpiece holders may be accumulated in front of the processing stations because of the loose linkage, so that a type of buffer exists.

Furthermore, any branches are possible in the traction mechanism conveyor line to be able to serve double processing stations, for example.

Moreover, a modular conveyor line allows a modularly constructed line or train of a manufacturing system, for example, multiple stations neighboring one another working together with the particular assigned transport modules, which form a continuous transport pathway for the components in a manufacturing, assembly, or testing train.

It is advantageous in particular in the type of configuration of the individual processing or testing stations described above if the transport modules are tailored to one another in such a way that each transport module may be withdrawn from the particular processing or testing station. For this purpose, the individual transport modules may have a compact construction without lateral interfering contours, so that the operator may replace the transport modules, preferably together with the assigned processing modules, by a simple withdrawal movement. Alterations of a manufacturing line and/or the transport pathway of a manufacturing system, for example, may thus be made possible in the simplest way.

Within the scope of an advantageous embodiment of the present invention, each transport module may include, as conveyor units, an intake belt for supplying workpiece holders having components to be processed, for example, and a return belt, situated parallel thereto, for returning the empty or equipped workpiece holders.

In this way, a component to be processed may be transported via the intake belt into the particular processing station, the processed component being able to be guided via the intake belt out of the processing station after processing in the assigned processing module. By arraying multiple processing stations having the assigned transport modules, two continuous transport routes thus are created, one for the intake of the workpiece holders and another in the opposite direction for the return transport of the workpiece holders.

In an advantageous embodiment of the present invention, at least one conveyor unit, in particular the intake belt, may be assigned at least one first relocation unit as a transfer unit, using which the workpiece holder having the component may be removed from the intake belt and supplied to a processing module for processing the component and may be removed from the processing module again after processing.

In the event of a rigid linkage of the processing modules, the relocation of the workpiece holders in the processing module is advantageous because the processing module may also be used during the transport of the workpiece holders from one processing station to the next. The processing module is often the most costly component of a processing station and may therefore be exploited optimally, because it is only idle during the relocation of the workpiece holders.

In this context, a further advantage of a relocation unit proposed according to the present invention is that two workpiece holders may be displaced using one relocation movement, by which the relocation time, i.e., the process idle time, is halved.

Moreover, the relocation in the processing module has the advantage that the workpiece holder and thus the workpiece may be oriented better toward the process because no transport belts obstruct the access to the workpiece holder therein.

In addition, a particularly suitable workpiece holder retainer may be provided for each manufacturing process.

It is also possible to move the workpiece holder in the processing module during the processing, e.g., by rotation about a vertical axis, so that the workpiece is always accessible.

The term relocation is not only to be understood to mean lifting and rotating the workpiece holders, however, but rather lifting and linear movement of the workpiece holders over longer routes may also alternatively be provided.

According to an advantageous embodiment, the workpiece holders, which are transported on the intake belt into the processing station having lateral protrusion, are stopped on the relocation unit via a stopper or the like assigned to the relocation unit, so that the relocation unit may remove the particular workpiece holder having the component from the intake belt and supply it to the processing module.

According to a refinement, the conveyor unit for supplying the workpiece holders, i.e., the intake belt, and the conveyor unit for returning the workpiece holders, i.e., the return belt, may be jointly assigned a second relocation unit, using which the workpiece holders, with or without the processed component, may be moved from the intake belt to the return belt or from the return belt to the intake belt.

For example, the second relocation unit may be situated between the intake belt and the return belt, so that it may relocate the workpiece holder having the processed component from the intake belt to the return belt or from the return belt to the intake belt.

Furthermore, it is expedient if each relocation unit has a height adjustment unit and/or a lift axis and a rotating unit for handling the workpiece holders using the device according to the present invention.

In a possible embodiment of the present invention, the height adjustment unit and/or lift axis has at least one pin pair, which is adjustable in height via a linear slide or the like and may engage in corresponding openings of the particular workpiece holder to lift the workpiece holder off of the intake belt, for example.

An extremely simple embodiment of the gripping aids on the transfer unit and on the workpiece holders is thus possible in the device according to the present invention, because using simple pins on the transfer unit and aligned holes on the workpiece holders, a lifting movement alone is sufficient to grasp a workpiece holder securely in position without a complex closing movement of a gripper being necessary for this purpose.

If two pin pairs are provided on the transfer or relocation unit, which are movable in height separately, one pin pair may advantageously be used in the process nest for workpiece holder positioning, while the other pin pair may lower a workpiece holder onto the conveyor belt and remove it again. Therefore, via two diametrically opposite pin pairs, the relocation unit may simultaneously convey an already finished component from the processing module and convey a component which has not yet been processed from the conveyor belt into the processing module, by which the changing times are further reduced.

As an alternative to the embodiment having pins on the transfer or relocation unit and holes on the workpiece holder, into which the pins are insertable, in further embodiments, depending on the application, any other known gripping mechanism may also be used for handling the workpiece holders.

To supply the workpiece holder raised from the intake belt to the processing module, according to a next refinement, a pivot drive may be provided as a rotating unit, which allows a rotation of the pin pair in a horizontal plane, preferably by 180°, to relocate the workpiece holders between the conveyor units and the processing module.

To provide a capability of ejecting faulty components from the component circulation in the device according to the present invention, the conveyor unit for returning the workpiece holders, i.e., the return belt, may have a third relocation unit assigned to it for ejecting faulty components. Therefore, incorrectly produced components may be relocated by the first and second relocation units from the intake belt to the return belt, to then finally eject the faulty component from the component circulation via the third relocation unit.

In all of the suggested embodiments, a lateral guide of the workpiece holders may be provided by at least one groove on the workpiece holder bottom.

In an advantageous refinement of the present invention, grooves intersecting at 90° are provided on the bottom of the workpiece holders so that the workpiece holder may be placed on the traction mechanism conveyor line in any position.

The device proposed according to the present invention is suitable in particular for use in manufacturing systems which include miniaturized, modularly constructed manufacturing modules or processing stations. However, it may also be used in testing stations or other treatment stations.

### BRIEF DESCRIPTION OF THE DRAWINGS

An exemplary embodiment of a device according to the present invention is schematically illustrated in simplified form in the figures and is explained in greater detail below.

FIG. 1 shows a schematic three-dimensional view of a transport module of a modularly constructed traction mechanism conveyor line for transporting workpiece holders to and from a processing station.

FIG. 2 shows a side view of the transport module according to FIG. 1.

FIG. 3 shows a schematic top view of two workpiece holders at a relocation unit of the transport module according to FIGS. 1 and 2 in a detached view.

### DETAILED DESCRIPTION OF EXAMPLE EMBODIMENTS

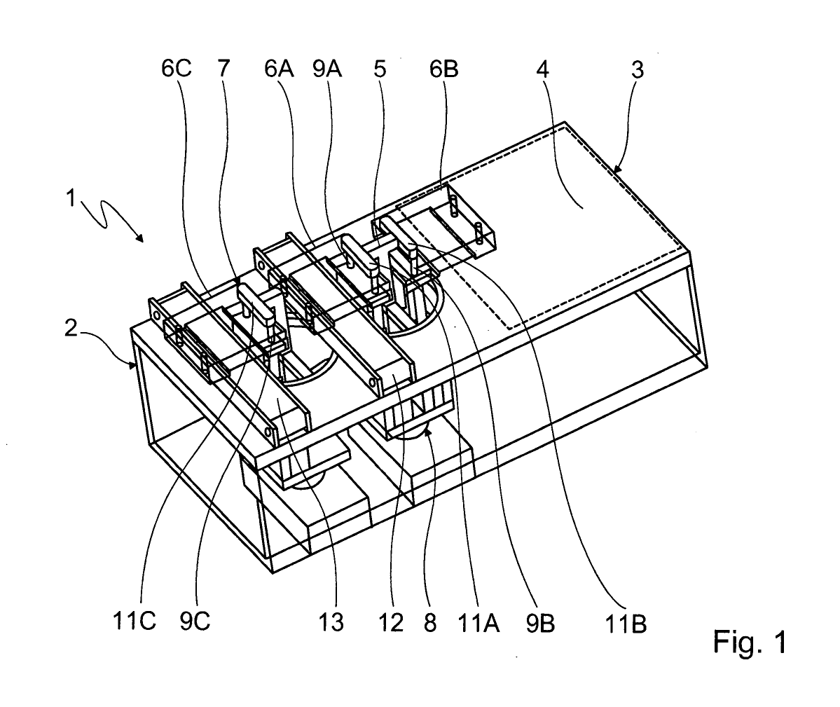

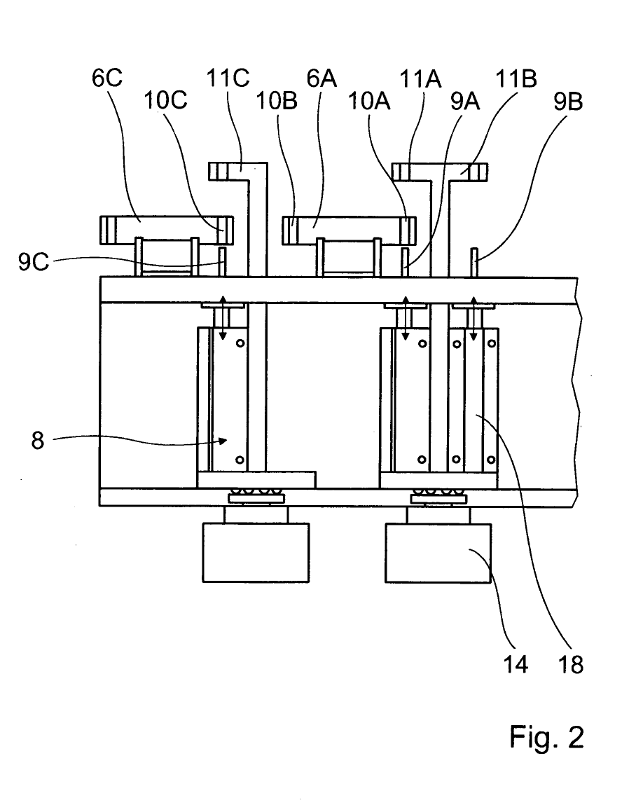

FIGS. 1 and 2 show a possible embodiment of a device according to the present invention having a traction mechanism conveyor line 1 for transporting workpiece holders 6A, 6B, 6C, on which components to be processed may be situated, traction mechanism conveyor line 1 being modularly constructed from multiple transport modules 2, of which only one processing module 4 of a processing station 3 is shown symbolically for exemplary purposes by a dashed line.

Traction mechanism conveyor line 1 is coupled to each processing station 3 for supplying and removing workpiece holders 6A, 6B, 6C and constructed modularly in such a way that a transport module 2 is assigned to each processing station 3.

Transport modules 2 of multiple neighboring processing stations 3 thus form a continuous transport pathway for workpiece holders 6A, 6B, 6C in the manufacturing area of processing stations 3.

Transport module 2 has, as conveyor units, an intake belt 12 for supplying a workpiece holder 6A, 6B, 6C having a component to be processed and a return belt 13 for returning the processed component or workpiece holder 6A, 6B, 6C.

Intake belt 12 and return belt 13 are situated approximately parallel to one another, intake belt 12 neighboring a processing module 4 provided for processing the component.

A first relocation unit 5, using which workpiece holder 6A, 6B, 6C is removable from intake belt 12 and may be supplied to processing module 4 for processing a component situated thereon, is assigned to intake belt 12 as a transfer unit of transport module 2. After the component is processed, workpiece holder 6A, 6B, 6C may be removed again from processing module 4 and initially placed on intake belt 12.

A second relocation unit 7, using which workpiece holder 6A, 6B, 6C having the processed component may be transported from intake belt 12 to return belt 13 to transport the finished component out of the manufacturing system, is provided between intake belt 12 and return belt 13 as a further transfer unit.

Transfer or relocation units 5, 7 are each situated generally below the conveyor plane of traction mechanism conveyor line 1 and are movable perpendicular thereto, the width of traction mechanism conveyor line 1 and workpiece holders 6A, 6B, 6C being selected in such a way that workpiece holders 6A, 6B, 6C, which lie loosely on traction mechanism conveyor line 1 and are guided thereon by grooves on their bottoms, project laterally beyond traction mechanism conveyor line 1.

Therefore, relocation units 5, 7 may grasp workpiece holders 6A, 6B, 6C from below at their areas projecting beyond traction mechanism conveyor line 1 via a lifting movement.

In the example embodiment shown in FIGS. 1 and 2, relocation units 5, 7 each accordingly have a height adjustment unit 8 and a rotation unit 14. Height adjustment unit 8 is implemented in the present case using pin pairs 9A, 9B, 9C, which are adjustable in height via a linear slide 18 and engage in corresponding openings 10A, 10C on particular workpiece holder 6A, 6B, 6C to handle workpiece holder 6A, 6B, 6C.

To bring raised workpiece holder 6A, 6B, 6C to processing module 4, in the embodiment shown, each relocation unit 5, 7 has a pivot drive 14 as a rotating adjuster, which allows rotation of pin pairs 9A, 9B, 9C in a horizontal plane.

To handle workpiece holder 6A, 6B, 6C securely using respective pin pair 9A, 9B, 9C, in the present embodiment a support arm 11A, 11B, 11C situated above the conveyor plane is provided in each case, using which the respective workpiece holder 6A, 6B, 6C may be clamped between pin pair 9A, 9B, 9C and receptacle 11A, 11B, 11C, which is situated aligned thereto.

To reduce the changing times of the components further, first relocation unit 5 is implemented as double-armed, a second pin pair 9B being situated parallel and symmetrically offset to an axis of rotation from first pin pair 9A, so that one workpiece holder 6A, 6B, 6C having an already processed component is removable from processing module 4 and simultaneously one workpiece holder 6A, 63, 6C having a component still to be processed may replace it by rotating relocation unit 5 by 180°.

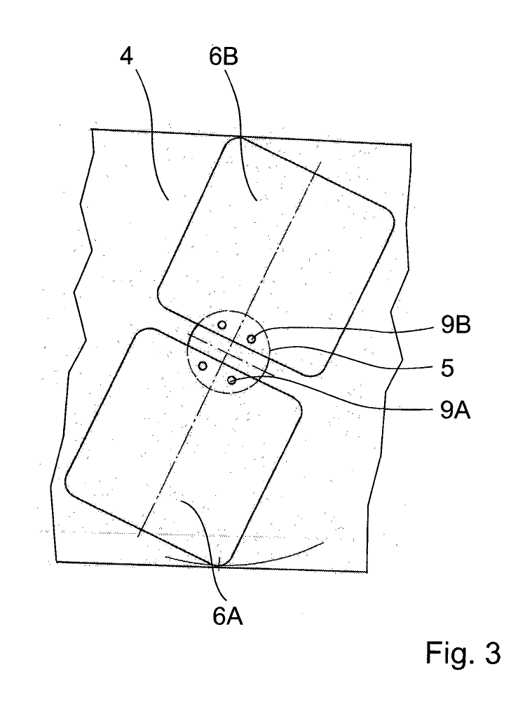

An important relationship between the width of processing module 4 and the dimensions of workpiece holders 6A, 6B, 6C results for a transfer unit like relocation unit 5 as a component of processing module 4 having a predefined compact width of 220 mm in the present case, for example, which is illustrated in FIG. 3. It may be seen therein how workpiece holder pair 6A, 6B is rotated within the module boundaries, the position being shown in which the corners of workpiece holders 6A, 6B are closest to the module boundaries.

It is significant here that the point of a workpiece holder which is furthest away from the axis of rotation of relocation unit 5 moves within the module boundaries, so that the relocation units of neighboring processing modules 4 or neighboring transport modules 2 may not mutually interfere with one another. This means that the maximum distance between the axis of rotation of relocation unit 5 and the furthest distal point of a workpiece holder corresponds at most to half of the module width, 90% of this upper limit being selected as a lower limit of this distance in a preferred embodiment.

To optimize the area of the preferably square workpiece holders 6A, 6B, 6C in the scope of these geometric predefinitions, the corners of the workpiece holders are provided with rounded areas in the exemplary embodiment shown.

In the following, the mode of operation of the device according to the present invention is described in summary.

Workpiece holders 6A, 6B, 6C having components to be processed are transported projecting laterally beyond intake belt 12 into processing station 3 using intake belt 12, workpiece holders 6A, 6B, 6C being stopped at first relocation unit 5 via a stopper.

Double-armed relocation unit 5 moves upward perpendicularly to the conveyance direction of traction mechanism conveyor line 1 and picks up workpiece holder 6A via first pin pair 9A by inserting the pins of pin pair 9A into corresponding openings 10A on workpiece holder 6A. Relocation unit 5 lifts workpiece holder 6A off of intake belt 12.

Simultaneously, workpiece holder 6B located in processing module 4 is picked up by the same relocation unit 5 using second pin pair 9B. Workpiece holders 6A, 6B are exchanged by a 180° rotation of relocation unit 5 and subsequently put down on intake belt 12 or in processing module 4 in a lowering movement. The component changing time is minimized and processing module 4 is optimally utilized by this movement sequence.

Second relocation unit 7 is implemented as single-armed in the present case and operates according to the same principle. Relocation unit 7 relocates the workpiece holder having the finished component from intake belt 12 onto return belt 13. Using one relocation unit at the beginning of a manufacturing line and one relocation unit at the end of the manufacturing line, a closed component circulation may thus be created by linking the belt advance and the belt return.

1-14. (canceled)

15. A device for transporting workpiece holders between multiple processing stations, comprising:
a traction mechanism conveyor line having at least one conveyor unit and at least one transfer unit adapted to transfer the workpiece holders between the traction mechanism conveyor line and a processing station;
wherein the workpiece holders lie loosely on the traction mechanism conveyor line and project laterally beyond the traction mechanism conveyor line, and the transfer unit is situated at least partially below a conveyor plane and movable perpendicular thereto in such a way that the workpiece holders are graspable from below by the transfer unit at an area of the workpiece holders projecting beyond the traction mechanism conveyor line.

16. The device as recited in claim 15, wherein the traction mechanism conveyor line includes, as conveyor units, an intake belt adapted to supply the workpiece holders, and a return belt, situated parallel thereto at a distance, adapted to return the workpiece holders, the traction mechanism conveyor line being implemented as a double-belt conveyor.

17. The device as recited in claim 15, wherein the traction mechanism conveyor line is constructed from multiple transport modules forming a continuous transport pathway, each of the transport modules being assigned to a specific processing station and having at least one conveyor unit and one transfer unit for the workpiece holders.

18. The device as recited in claim 17, wherein each of the transport modules includes a conveyor unit for supplying the workpiece holders and a conveyor unit for returning the workpiece holders.

19. The device as recited in claim 18, wherein the conveyor unit for supplying the workpiece holders is assigned at least one first relocation unit as a transfer unit, using which the workpiece holders may be removed from the conveyor unit and supplied to a processing module of the processing station and may be removed from the processing module again after a process sequence.

20. The device as recited in claim 19, wherein the first relocation unit is assigned at least one stopping element for stopping the workpiece holders on the conveyor unit.

21. The device as recited in claim 19, wherein a conveyor unit for supplying the workpiece holders and a conveyor unit for returning the workpiece holders are jointly assigned a second relocation unit, using which the workpiece holders may be moved from the conveyor unit for supplying the workpiece holders to the conveyor unit for returning the workpiece holders.

22. The device as recited in claim 19, wherein a height adjustment unit of the relocation unit has at least one pin pair, which is adjustable in height via a linear slide and which engages in corresponding openings of the particular workpiece holder to handle the workpiece holder.

23. The device as recited in claim 19, wherein the relocation unit includes a rotating unit implemented as a pivot drive which is designed to rotate the workpiece holders in a horizontal plane.

24. The device, as recited in claim 20, wherein the rotating unit rotates the workpiece holder by at least 180°.

25. The device as recited in claim 23, wherein the rotating unit grasps the workpiece holders using at least one pin pair.

26. The device as recited in claim 19, wherein the first relocation unit has two pin pairs situated symmetrically to an axis of rotation, each pin pair being provided to engage in one workpiece holder.

27. The device as recited in claim 11, wherein each of the pin pairs is assigned a corresponding support arm.

28. The device as recited in claim 19, wherein the conveyor unit for returning the workpiece holders is assigned a third relocation unit for ejecting faulty components.

29. The device as recited in claim 15, wherein at least one groove is formed on the bottom of the workpiece holders to guide the workpiece holders on the traction mechanism conveyor line to guide them laterally.
